(19) United States
(12) Patent Application Publication
(10) Pub. No.: US 2008/0129662 A1
(43) Pub. Date: Jun. 5, 2008

(54) Method, medium, and display system with enlarged apparent size

(75) Inventors: Myung-hyun Yoo, Seongnam-si (KR); Gyung-hye Yang, Seoul (KR); Yong-beom Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/907,295

(22) Filed: Oct. 10, 2007

(30) Foreign Application Priority Data
Oct. 11, 2006 (KR) 10-2006-0099006

(51) Int. Cl. G09G 3/34

(52) U.S. Cl. 345/84

(57) ABSTRACT

A display method, medium, and system having an enlarged apparent size greater than a display size of a corresponding display panel. The display device may include a display panel outputting input image data, and a periphery element making up the boundary of the display panel, such that the periphery element gradually varies generation of light in brightness and color so as to cause a viewer to perceive continuity between the display panel and the periphery element.

### CROSS-REFERENCE TO RELATED APPLICATION

This application claims priority from Korean Patent Application No. 10-2006-0099006 filed on Oct. 11, 2006 in the Korean Intellectual Property Office, the disclosure of which is incorporated herein by reference in its entirety.

### BACKGROUND

1. Field

One or more embodiments of the present invention relate to an apparent observable size of a display panel, and more particularly, to a method, medium, and display system providing an enlarged apparent observed size such that one or more frames making up a boundary of a display panel are controlled to gradually vary in brightness and color, without having to actually increase a physical size of the display panel, thereby inducing an optical illusion to a viewer. As a result, even with a relatively small sized display panel, a viewer can perceive an enlarged apparent size for the display panel.

2. Description of the Related Art

With the current progress of communication technologies, viewers have become able to receive an enormous quantity of information. Accordingly, to satisfy viewers' desire to enjoy more realistic virtual images and with such huge quantities of information, there is a continual trend toward larger-sized display panels. The size of a display panel is typically limited by the size of the base plate glass of the display panel. Thus, to change the size of the display panel, the underlying architecture of the corresponding production line needs to be altered, which is time consuming and cost-ineffective.

Visual stimuli corresponding to visual information take up several features including shape, color, motion, etc. The respective features are combined to form visual content as meaningful information, which can be provided to a viewer through information display media, such as the above mentioned display panel. Thus, the human visual system processes visual stimuli presented on a display screen through different visual channels and finally integrates the processed visual stimuli in the brain to capture the overall image. In the course of this processing, color and brightness are basic factors in identifying features of the overall image. When processed by an ocular system, e.g., the human eye, color information has a perceptual feature in that that it cannot be associated with a clearly distinct contour or edge of an image plane.

Color information making up an image plane tends to spread out unless the image plane encounters another distinct boundary. This property can similarly apply to a case of brightness information. That is, brightness information of a particular plane spreads out until the plane encounters another distinct boundary. Reportedly, a color spreading extent ranges from about 3 degrees, which would illuminate substantially half of the center of the eye's focal area, i.e., the fovea, to about 40 or more degrees in visual angle. With this understanding by the inventors and with similar understanding of the conventional drawbacks, by utilizing such color and brightness features, embodiments of the present invention will be discussed below through a periphery of a display panel being controlled to gradually change from dark to bright, thereby making a user perceive a discontinuity between the display panel and the corresponding display panel frames. As a result, the user perceives that the frames are also part of the display panel.

With these aforementioned drawbacks in mind, such a conventional system includes an ambient light television (Ambilight TV), proposed by Philips Electronics. This Philips' Ambilight TV is configured such that a background lighting unit is separately installed to the corresponding display and RGB color tones shown within the display panel are automatically sensed by a viewer by a projecting of the background lighting from the rear of the TV onto the wall behind the display. Here, indirect lighting illuminated dimly backward moderates the intensity of light projected on the screen, so that the motion of a viewer's iris muscle is reduced, thereby allowing the user to watch TV in a more comfortable manner. Thus, though not achieving the above mentioned advantage of one or more embodiments of the present invention, this ambilight TV may offer a different enjoyable TV viewing experience to the user simply by reducing the contrast with regard to the background, so that eyestrain or viewing fatigue may be substantially reduced. With the configuration of the existing ambilight TV, however, again, a sensation of discontinuity between the display panel and one or more of the frames is still perceived by the viewer. Thus, with such a system, it is not possible to make the viewer perceive a display panel size as being larger than its actual size.

Similarly, Japanese Unexamined Patent No. 2005-284108 (Liquid Crystal Display Panel and Large-sized Liquid Crystal Display) discusses a liquid crystal display panel wherein a display screen of the liquid crystal display panel, using a chiral nematic liquid crystal, can be viewed more widely than a real liquid crystal encapsulation region. However, here, again, such an arrangement fails to set forth a methodology so that a viewer should not perceive a sensation of discontinuity between the display panel and the frames.

Thus, by implementing the above mentioned advantage of one or more embodiments of the present invention, such drawbacks and disadvantages can be overcome.

### SUMMARY

One or more embodiments of the present invention provide a method, medium, and display system with an enlarged apparent size.

Additional aspects and/or advantages will be set forth in part in the description which follows and, in part, will be apparent from the description, or may be learned by practice of the invention.

To achieve the above and/or other aspects and advantages, embodiments of the present invention include a display system, the display system including a display panel to display image data, and one or more periphery display elements to project light beyond a corresponding periphery extent of the display panel to generate an optically observable boundary beyond the display panel, with respective light projection of the one or more periphery display elements being selectively controlled to gradually vary projection of light in brightness and/or color to reduce a viewer perceivable sensation of discontinuity between the corresponding periphery extent of the display panel and the boundary.

To achieve the above and/or other aspects and advantages, embodiments of the present invention include a display system, the display system including a display panel to output image data, and a means to vary projection of light beyond a periphery of the display panel in brightness and/or color for reducing a viewer perceivable sensation of discontinuity between the periphery of the display panel and the means.

To achieve the above and/or other aspects and advantages, embodiments of the present invention include a display method, the method including analyzing image data for display, and calculating and outputting controlling signals for controlling a projecting of light beyond a corresponding periphery extent of a display panel to generate an optically observable boundary beyond the display panel, with the controlled respective light projection of the light selectively controlling the respective light projection to gradually vary projection of light in brightness and/or color to reduce a viewer perceivable sensation of discontinuity between a corresponding periphery extent of the display panel and the boundary.

To achieve the above and/or other aspects and advantages, embodiments of the present invention include a method for enlarging an apparent size of a display panel, the method including analyzing brightness and color information of image data, calculating optimum levels of at least one varying of corresponding brightness and color for one or more periphery elements attached to the display panel based on the analyzed brightness and color information, with the optimum levels being set such that a viewer observable sensation of discontinuity between the display panel and the one or more periphery elements is meant to be imperceptible, and driving an illumination source respectively of the one or more periphery elements according to the calculated optimum levels of the varying of the corresponding brightness and color.

### BRIEF DESCRIPTION OF THE DRAWINGS

These and/or other aspects and advantages will become apparent and more readily appreciated from the following description of the embodiments, taken in conjunction with the accompanying drawings of which:

FIGS. 1A through 1D illustrate examples where an apparent size of a display is enlarged due to a display panel boundary vagueness;

FIG. 2 illustrates an apparatus/system adjusting an apparent size of a display panel, according to an embodiment of the present invention;

FIG. 3 illustrates such an apparatus/system adjusting an apparent size of a display panel, according to an embodiment of the present invention;

FIG. 4 illustrates a variation in the visual sensitivity depending on eccentricity, according to an embodiment of the present invention; and

FIG. 5 illustrates a method adjusting an apparent size of a display panel, according to an embodiment of the present invention.

### DETAILED DESCRIPTION OF EMBODIMENTS

Reference will now be made in detail to embodiments, examples of which are illustrated in the accompanying drawings, wherein like reference numerals refer to the like elements throughout. In this regard, embodiments of the present invention may be embodied in many different forms and should not be construed as being limited to embodiments set forth herein. Accordingly, below, embodiments are described below to explain the present invention by referring to the figures.

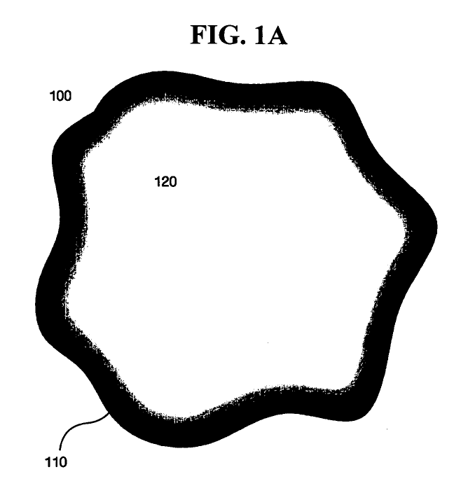

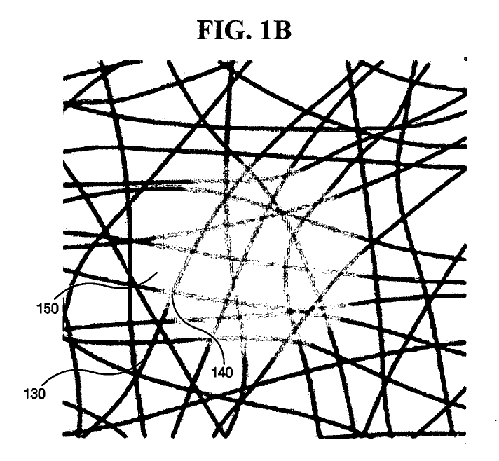

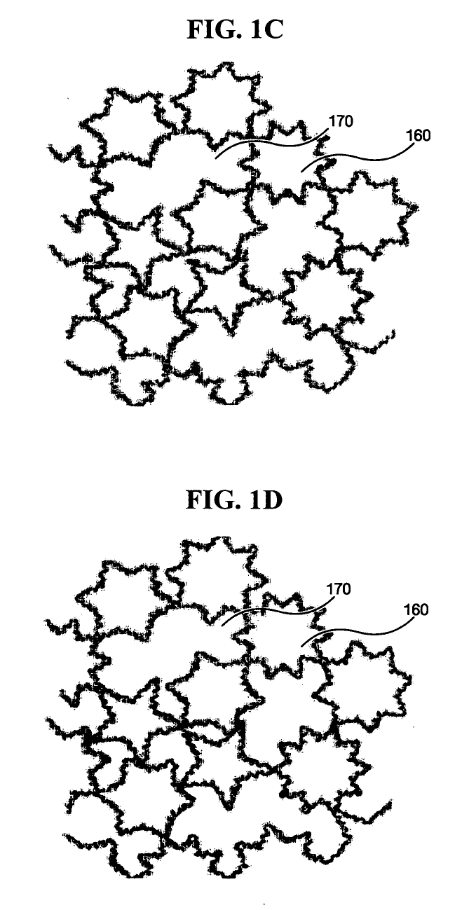

FIGS. 1A through 1D illustrate examples where an apparent size of a display is enlarged due to a display panel boundary vagueness.

Referring to FIG. 1A, the shown image plane has a distinct boundary defined by a closed curve, with a gradation 110 being provided from an inside area 120 of the closed curve to an outside area 100 of the closed curve. Here, the gradation 110 indicates changes in color gradually provided from darker colors to lighter colors, thereby creating a vagueness along the boundary between the outside area 100 and inside area 120 of the closed curve. As stated above, brightness information making up an image plane tends to spread out unless the image plane encounters another distinct boundary. Here, as shown in FIG. 1A, the brightness information is displayed in a state in which it spreads from the outside area 100 to the inside area 120 of the closed curve until a portion of the image plane where the gradation 110 terminates. Accordingly, an optical illusion is generated suggesting that the inside area 120 of the closed curve extends toward the boundary contiguous to the outside area 100 of the closed curve due to the gradation 110.

Referring to FIG. 1B, an exterior area 130 of an imaginary boundary line defining an image plane has a plurality of dark lines and an interior area 140 thereof has a plurality of blurred lines. The blurred interior area 140 is displayed in a state in which it appears to be spreading out and a circular-shaped, such that an imaginary boundary 150 becomes visually perceived from the spreading or diffusion of color and brightness.

FIGS. 1C and 1D illustrate exemplary patterns of color spreading (diffusion) in examples of stellar closed curves, where color information spreads from an inside area 160 to an outside area 170 of the stellar closed curve, or vice versa, according to the location of a corresponding distinctly contoured boundary.

Referring first to FIG. 1C, in each of the stellar closed curves, the boundary thereof is defined by a solid darker line, e.g., of a the color black, that is contiguous to the inside area 160 and a lighter color line, e.g., of the color brown, with gradation that is contiguous to the outside area 170. In this case, since color information does not spread out toward a distinctly contoured boundary, the lighter color components are displayed in a state in which they spread toward the outside area 170, which makes the outside area 170 look darker than the inside area 160. However, in this example, the color and brightness levels of the inside area 160 are actually the same as those of the outside area 170.

Referring to FIG. 1D, in each of the stellar closed curves, the boundary thereof is defined by such a lighter color line with gradation that is contiguous to the inside area 160 and such a solid darker color line that is contiguous to the outside area 170. In this case, since color information does not spread out toward a distinctly contoured boundary, the lighter color components are displayed in a state in which they spread toward the inside area 160, which makes the outside area 170 look darker than the inside area 160. However, in this example, the color and brightness levels of the inside area 160 are actually the same as those of the outside area 170.

Thus, according to one or more embodiments of the present invention, a color and brightness spreading phenomena perceived by human visual systems can be induced by controlling light output by frames of the display panel, so that the display panel becomes visually perceived as being larger.

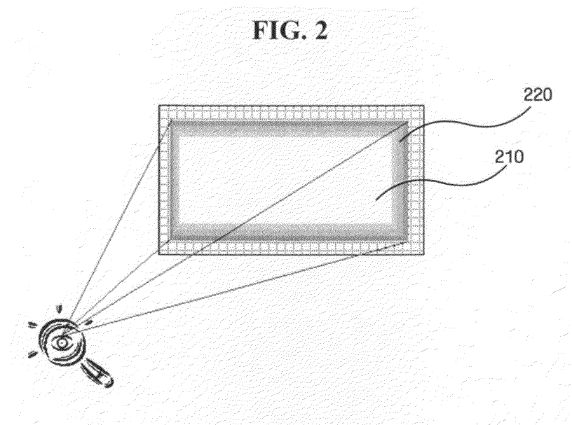

FIG. 2 illustrates an arrangement of an apparatus/system manipulating an apparent size of a display panel, according to an embodiment of the present invention. Here, in an embodiment, the apparatus shown in FIG. 2 may be such a display panel.

The example display panel shown in FIG. 2 is physically confined to an inside area 210. However, gradation 220 can be provided by frames of the display panel to induce the aforementioned color and brightness spreading phenomenon described in FIGS. 1A-1D, thereby generating a vagueness along the boundary between the display panel and the frames. Accordingly, with such an arrangement, a viewer may not perceive the sensation of discontinuity between the display panel and the frames, so that the viewer will actually perceive an enlarged image that reaches a termination area of the gradation 220.

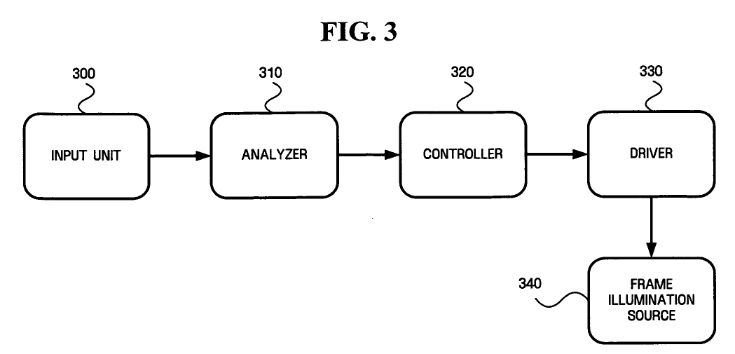

FIG. 3 illustrates such an apparatus/system for adjusting an apparent size of a display panel, according to an embodiment of the present invention. Again, in this embodiment, the apparatus shown in FIG. 3 may be such a display panel.

The apparatus, e.g., the display panel or display panel system, shown in FIG. 3 may include an input unit 300, an analyzer 310, a controller 320, a driver 330, and a frame illumination source 340, for example.

The input unit 300 may receive image data to be displayed on the display panel.

Presently, examples of display panels include LCDs (Liquid Crystal Displays), PDPs (Plasma Display Panels), and the like, with systems employing such LCDs or PDPs including TVs, computer monitors, PMPs (Portable Multimedia Players), DMB (Digital Multimedia Broadcasting) players, and the like, noting that alternate embodiments are equally available.

In a case where the shown display panel system is a TV system, for example, the image data is typically image data with wired or wireless communications transmitted from a broadcasting station via a coaxial cable, for example. When the shown display panel system is a computer system, e.g., with the display panel being part of a monitor, the image data is typically information or various types of multimedia data supplied from a PC terminal connected to the monitor, or the like. In addition, in a case where the shown display panel system is used as a PMP, the image data is typically multimedia data or DMB broadcasting programs, e.g., moving picture files stored for user's later viewing while enjoying the advantage of portability. Still further, only as an example, in a case where the shown display panel system is used as a mobile phone, the image data is typically multimedia text messages exchanged between users, multimedia data from wireless Internet, or DMB broadcast image data to be implemented on the display panel. Again, the listing and providing of such examples should not be considered as limiting of embodiments of the present invention, as alternate embodiments are equally available.

Referring to FIG. 3, the analyzer 310 may analyze information about the brightness and/or color of image data, e.g., image data sent from the input unit 300.

Here, for example, the analyzer 310 may separate image data into brightness information and/or color information and then analyze the same. The referenced brightness information corresponds to the lightness of a color, for example. The lightness may literally mean a light intensity level of a color. In view of the light intensity level, the color white can be understood to be a highest level and, conversely, while the color black may be understood to be a lowest level. For example, the higher the lightness of a color, the closer the color is to white, and similarly, the lower the lightness of a color, the closer the color is to black. When a color has a high level of lightness, this means that the color is bright. Here, every color has its own brightness even without being mixed with white or black. Among pure colors, yellow can be understood to have the highest level of lightness and violet or red can be understood to have the lowest level of lightness. Thus, every color has its own lightness.

Here, the color information corresponds to information enabling color differentiation. A color with a color tone is called a chromatic color, whereas a color without a color tone is called an achromatic color, e.g., black, gray, and white.

Unlike in CRT devices, where an input video signal is scanned as input, without any processing or conversion, in digital displays a digital display panel processes and displays digital images, such as a PDP, LCD, or the like, with analog image data generally being analyzed in the form of a digital signal, converting the video signal into a signal in a format that can be displayed on the display panel.

Further, according to an embodiment of the present invention, the analyzer 310 may, thus, receive predetermined multimedia information (visual input information) from the input unit 300, for example, and separate the same into a signal Y indicating brightness or luminance, and chrominance signals R-Y and B-Y, for example. Here, the example chrominance signals R-Y and B-Y can be used in reconstructing an RGB signal representing color components red (R), green (G), and blue (B). Alternate color formats and distinguishments between the brightness and color are also available.

The controller 320 may calculate optimum levels of the brightness and/or color of the frames in a boundary portion of the display panel using the information about the brightness and/or color analyzed in the analyzer 310, for example. Here, in an embodiment, the optimum levels may thus indicate brightness and color levels which can effectuate an optimally enlarged apparent size of the display panel.

In this embodiment, in order to effectuate such a brightness and color spreading effect from the display panel along the frames, the optimum levels may be optimally set toward the point where the sensation of discontinuity between the display panel and the frames is not perceived by a viewer, suggesting that there may not be sharp differences in the brightness and color levels between the display panel and the frames in the boundary portion. Therefore, these example optimum levels of the brightness and color of the frames may be obtained based on the brightness and color levels of the image data to be reproduced on the display panel, thereby making the brightness and color of the frames gradually vary.

Thus, the brightness and color of the frames in the boundary portion of the display panel may be adjusted in consideration of a viewer's optical perception.

Regarding optical perceptions, in the human eyes, cones function to perceive high brightness levels and are plump cells densely packed at the retina of the eye, and particularly at the center of the eye's focal area, the fovea. The cones sense light of 0.1 Lux or greater, and are also called pyramidal cells.

The human eye has a physiological aspect in that it is capable of minutely discriminating one color from another owing to the operation of the cones. The retina of the human eye contains approximately 7 million cones. Further, there are three kinds of cones, each sensitive to its own range of wavelengths within the visible light spectrum. These three kinds of cones are referred to as red cones, green cones, and blue cones because of their respective sensitivity to the wavelengths of light which are associated with red, green and blue. Thus, a variety of colors can be identified as a function of the three kinds of cones. This is substantially the same principle of full color creation used by color television or computer graphic programs by combining colors of red, green and blue in appropriate ratios.

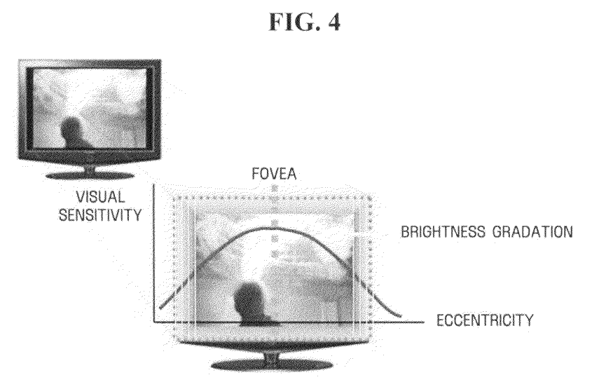

FIG. 4 illustrates a variation in the visual sensitivity depending on eccentricity, according to an embodiment of the present invention.

The resolution of the human eye is highest in the fovea, corresponding to the center of the eye's focal area, which is also the most sensitive area to external visual information. The maximum number of cones is also found in the fovea and decreases as the distance from the fovea is increased. Therefore, the visual sensitivity is highest in the fovea and decreases as the distance from the center of the eye's focal area, referred to as eccentricity, increases.

In general, when a viewer views a display panel, the display panel may typically display information along an internal visual angle of about 25 to 35 degree from a center point of the display. Since the distance from the fovea, i.e., the eccentricity, is expressed in degrees of visual angle, an increase in the visual angle similarly implies an increase in the eccentricity.

A variation in the brightness of frames of the display panel may also be given by visual sensitivity depending on the eccentricity indicating a distance from the center of left and right eyes by the following Equation 1, for example.

S=−|log X|+T Equation 1

Here, X denotes eccentricity, and T denotes a sensitivity constant in the fovea and corresponds to the maximum brightness at the center of the display panel, for example, with the brightness levels gradually decreasing from the display panel to the frames.

Based on the variation in the visual sensitivity, the controller 320 may calculate a reduction ratio of brightness for the frames and drive the example frame illumination source 340 to control the perception of a viewer to reduce the sensation of discontinuity between the display panel and the frames.

In addition, color adjustment may also be performed, e.g., based on the distribution of the cones. That is to say, using basic color parameters of example RG 40/Y 50/B60 combinations in consideration of characteristics of the human visual system, color combinations of gradation may be adjusted such that concentrations of RG, Y, B color components are present in the descending order as the distance from the fovea increases tones, that is, with the distribution of cones depending on the respective wavelengths for vision.

Here, these referenced numerical values 40, 50 and 60 indicate visual angles relative to the fovea. As the visual angle increases, a cone distribution decreases, suggesting that the capability of color perception is lowered. As described above, there are three kinds of cones, each sensitive to its own range of wavelengths of light associated with R, G, and B, and their respective distributions vary according to locations of the retina ranging from the fovea to the periphery. The RG components are highly concentrated on the fovea (corresponding to a relatively small area in visual angle), while the Y and B components are present even in the peripheral area.

Accordingly, in an embodiment, based on characteristics of the human visual system, advantages and merits of embodiments of the present invention may be achieved using light having high RG components in the central area of the display panel and light having high YB components, e.g., gray light, in the area farther from the central area of the display panel.

Thus, the controller 320 may calculate an optimum level of brightness to be applied to the example frame illumination source 340, e.g., such that the brightness gradually decrease from the central area of the display panel to the peripheral area of the display panel. In this example, the peripheral area of the display panel can be represented by the frames, thereby potentially defining a boundary of the display panel. Here, in an embodiment, criteria for setting the optimum level of brightness depends upon the visual sensitivity, and respective color components may be adjusted such that RC components are enhanced in the fovea and YB components are enhanced in areas distant from the fovea.

Referring to FIG. 3 again, the driver 330 may drive the example frame illumination source 340, e.g., installed in/with the frames along the boundary of the display panel, based on the optimum levels of brightness and color, e.g., as calculated in the controller 320. Based on the calculated optimum levels of brightness and color of the frames, the driver 330 may, thus, control illuminators to turn on or off the illuminators, for example.

In an embodiment, the frame illumination source 340 may be installed within the frames of the display panel and may be an illuminator that can be selectively turned on and off, for example, under the control of the driver 330.

As the frame illumination source 340 is selectively turned on and off, each of the frames of the display panel may have its own brightness and color levels with gradation, thereby producing a brightness and color spreading effect so that visual information reproduced on the display panel can be displayed even in the frame area in a diffused manner.

In an embodiment, the frame illumination source 340 may include an array of light emitting diodes (LEDs), for example. Here, the LEDs produce carriers (electrons and holes) using p-n junction of a semiconductor and emit light of various wavelengths by recombination of electrons and holes at the p-n junction. Compared to conventional non-LED light illumination sources, LEDs are advantageous because they have various benefits, including their compact size, long-lasting lifetime, low power consumption, and high efficiency due to a direct electrical-to-optical energy conversion, etc. In addition, since LEDs emit light of various wavelengths depending on the type of semiconductor material used, different LEDs can provide a full array of colors. Furthermore, advantageous features of LEDs, including semi-permanently long service life and low power consumption, have led to their accelerated commercialization. Compared to incandescent lamps, LEDs consumes lower power, e.g., of not greater than 10%, while still producing the same amount of light. When practically used with a wide range of applications, LEDs exhibit the maximum service lifetime of about 10 years without malfunction, ensuring highly reliable products. Further, with the advance of semiconductor technologies, the manufacturing costs of LEDs is continuously decreasing. Lastly, due to their high response speed, LEDs have been spotlighted in a wide range of applications, such as in display devices for automobile guages, display lamps for various types of electric devices, such as a light source for optical communications, a digit display device, a card reader for a cashier or check-out counter, etc. Here, though a detailed discussion of LEDs has been provided, embodiments of the present invention are not limited thereto, i.e., alternate sources of light are equally available.

Thus, in an embodiment, the frame illuminator 340 may include an LED illuminating diffusing element used in combination with an LED. Since the LED illuminating diffusing element serves to spread the brightness of the LED, the frame illuminator 340 may exhibit better performance when the LED illuminating diffusing element is used in combination with the LED.

Such a LED illuminating diffusing element may support 16 million colors, for example, represented by combinations of primary three colors of red, green and blue. With a reduction in the use of LEDs by about 20%, the LED illuminating diffusing element may also still have substantially similar luminous intensity, implying an advantageous feature in view of cost saving. Further, since the LED illuminating diffusing element may further be made of flexible material, it can be easily subjected to an extrusion or formation process. Another advantageous feature of the LED illuminating diffusing element is associated with its high versatility according to the shape of display, which is possible because LED illuminating diffusing elements may not be susceptible to cracks or damages.

In an embodiment, the frame illuminator 340 may further include a cold cathode fluorescent lamp (CCFL), for example, which is turned on at low temperature without a filament heated. The example CCFL may typically be constructed by electrodes disposed at opposite ends of a hollow glass cylinder which contains predetermined amounts of mercury, and a mixture of gasses such as argon and neon. The CCFL has similar construction as a typical fluorescent lamp in the hollow glass cylinder coated with a phosphor material. However, here, the typical fluorescent lamp and the CCFL are different from each other in view of electron emission. That is to say, while electron emission is initiated by heating in the typical fluorescent lamp, a high-voltage electric field created between two electrodes initiates electron emission of the CCFL.

Thus, in this embodiment, when a high voltage is applied to the electrodes, ultraviolet energy is produced as the mercury is excited. The resulting ultraviolet energy stimulates phosphors on the wall of the glass cylinder, producing visible light for electroluminescence. The CCFL is widely used as a light source in many applications, including backlight unit (BLU) for a LCD, a fax machine, a scanner, a copier, a panel display, and other ornamental applications.

In another embodiment, the frame illuminator 340 may include an external electrode fluorescent lamp (EEFL), for example. The EEFL has external electrodes, unlike the CCFL having electrodes within lamps, and emits light by plasma discharge induced to the lamps using an electric field applied to the electrodes. In addition, since the electrodes are installed outside the EEFL, the EEFL is free from the risk of heat dissipation. Further, the EEFL is advantageous for their prolonged lifetime. The EEFL is advantageous in operating in parallel with a reduced driving voltage, i.e., about 1500 V, compared to a conventional CCFL, thereby reducing power consumption of at least 50%. Further, since the EEFL has brightness of more than 400 nit, which is 60% greater than brightness of a CCFL, the EEFL can expand the TFT-LCD application field such as TV. In addition, unlike a CCFL having electrodes within lamps, the EEFL has external electrodes and thus is advantageous in operating in parallel, such that a uniform brightness can be realized by reducing a voltage deviation between the lamps.

In still another embodiment, the frame illuminator 340 may include an organic light emitting diode (OLED), for example.

The OLED is also called an organic diode or organic (EL). The OLED becomes self-emissive through an organic material using electroluminescence in which the organic material, called a self-emissive organic substance, spontaneously emits light when current flows through a fluorescent organic compound. The OLED has advantages of low-driving voltages and thin and small features. In addition, unlike a general LCD, the OLED provides no change in picture quality while not leaving residual images due to its wide viewing angle and fast response speed. Further, when used with small-sized displays, the OLED is cost-effective owing to its superb picture quality and simplified manufacturing process compared to the general LCD.

There are several types of color representation: independent pixel method of 3 colors (Red, Green, Blue); a color conversion media (CCM) method; and a method using a color filter, for example. In addition, OLEDs can be classified into a small-molecular OLED and high-molecular OLED according to light-emitting materials used in display. OLEDs can also be divided into passive matrix OLEDs and active matrix OLEDs.

Still further, all light-emitting elements capable of varying the brightness of frames, for example, of a display panel, including, for example, a laser, may be used as OLEDs.

Alternatively, an embodiment may include applying a translucent color coating to an entire area of the display panel by providing gradation to gradually change the overall color of the display panel from lighter to darker toward the frames. The translucent color coating can effectuate naturally continuity between the display panel and frames in the boundary of the display panel.

Thus, in an embodiment, in order to effectively realize the brightness and color spreading phenomenon in a course of manufacturing display panel and frames, for example, a coating may be applied to the entire surface of the display panel and brightness and color gradations may then be provided to the example frames by researching the average brightness and color levels of images displayed on display panels, for example.

In an alternative embodiment, a brightness of the boundary of the display panel may be adjusted using light and/or colors and processing then performed so as to make the contour and/or edge portion of the display panel vague to induce an optical illusion to a viewer, thereby ultimately making the viewer perceive an enlarged size of the display panel.

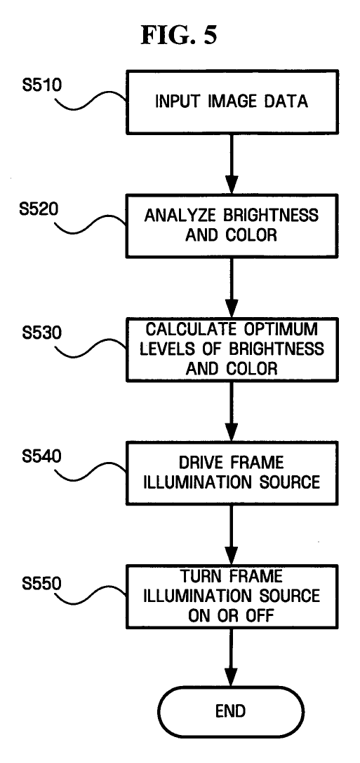

FIG. 5 illustrates a method of adjusting an apparent size of a display panel, according to an embodiment of the present invention.

In operation S510, image data may be input to the display panel.

In operation S520, information about the brightness and color of the image data may be analyzed. For example, an analyzer, e.g., analyzer 310 of FIG. 3, may perform signal processing on the information about the brightness and color of the image data, e.g., in a digital manner.

In operation S530, optimum levels of the varying brightness and/or color of the frames may be calculated, e.g., using the analyzed information about the brightness and color. Here, the optimum levels may indicate brightness and color levels which can effectuate an optimally enlarged apparent size of the display panel. An example calculation procedure can be seen with the above referenced controller 320 of FIG. 3, noting that alternatives are available.

In operation S540, a frame illumination may be performed, e.g., by the frame illumination source 340 of FIG. 3, according to such calculated optimum values of the brightness and/or color. Accordingly, in such an example, the frame illumination source 340 may be selectively turned on and off in operation S550. Examples of such a frame illumination source 340 are set forth above with reference to FIG. 3, again noting that alternatives are equally available.

The term ‘module’, as used above, means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described embodiments, embodiments of the present invention can thus be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As described above, according to one or more embodiments of the present invention, a brightness and color levels of frames of a display panel may be made to gradually vary so as to cause boundary vagueness, thereby inducing an optical illusion to a viewer, providing the effect of a spreading or diffusion of color and brightness. Accordingly, a boundary between the display panel and a frame may be made vague, thereby making the viewer unable to perceive a sensation of discontinuity between the display panel and the frame. Therefore, an image reproduced on the display panel may appear to the viewer as if the image is larger than the actual screen size.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A display system, the display system comprising:
a display panel to display image data; and
one or more periphery display elements to project light beyond a corresponding periphery extent of the display panel to generate an optically observable boundary beyond the display panel, with respective light projection of the one or more periphery display elements being selectively controlled to gradually vary projection of light in brightness and/or color to reduce a viewer perceivable sensation of discontinuity between the corresponding periphery extent of the display panel and the boundary.

2. The display system of claim 1, wherein at least one periphery display element is a frame, attached to of the display panel, comprising at least one light source.

3. The display system of claim 1, further comprising:
an analyzer to analyze information about at least one brightness and color of the image data;
a controller to calculate optimum levels of the gradually varying of the projection of the light in the brightness and color of at least one periphery display element based on the analyzed information about the at least one brightness and color of the image data, with the optimum levels being set such that the sensation of the discontinuity between the corresponding periphery extent of the display panel and the boundary is meant to be imperceptible; and
an illumination source formed with the at least one periphery display element to perform varying of perceived brightness and color levels of the at least one periphery display element.

4. The display system of claim 3, further comprising a driver to drive the illumination source to selectively turn on and off according to the calculated optimum values.

5. The display system of claim 3, wherein the controller calculates the optimum levels of the gradual varying of the projection of the light in the brightness of the at least one periphery display element based on visual sensitivity, as represented as:
S=−|log X|+T,
wherein X denotes eccentricity, and T denotes a defined sensitivity constant for a fovea and corresponds to a maximum brightness at a center of the display panel, with brightness levels gradually decreasing from the center of the display panel to the at least one periphery display element.

6. The display system of claim 3, wherein the controller calculates color values for the projection of the light by the at least one periphery display element such that color values relatively close to a defined sensitivity range of a fovea are enhanced for high RG components, and color values relatively far from a defined sensitivity range of the fovea are enhanced for high YB components.

7. The display system of claim 3, wherein the illumination source includes a light emitting diode (LED).

8. The display system of claim 3, wherein the illumination source includes an LED illuminating diffusing element used in combination with an LED.

9. The display system of claim 3, wherein the illumination source includes a cold cathode fluorescent lamp (CCFL).

10. The display system of claim 3, wherein the illumination source includes an external electrode fluorescent lamp (EEFL).

11. The display system of claim 3, wherein the illumination source includes an organic light emitting diode (OLED).

12. The display system of claim 1, wherein a translucent color coating is applied to one or more areas of the display panel that are respectively proximately close to the one or more periphery elements.

13. The display system of claim 1, wherein the display system is one of a TV system, a computer system, a portable multimedia player system, and a digital multimedia broadcasting system.

14. A display system, the display system comprising:
a display panel to output image data; and
a means to vary projection of light beyond a periphery of the display panel in brightness and/or color for reducing a viewer perceivable sensation of discontinuity between the periphery of the display panel and the means.

15. A display method, the method comprising:
analyzing image data for display; and
calculating and outputting controlling signals for controlling a projecting of light beyond a corresponding periphery extent of a display panel to generate an optically observable boundary beyond the display panel, with the controlled respective light projection of the light selectively controlling the respective light projection to gradually vary projection of light in brightness and/or color to reduce a viewer perceivable sensation of discontinuity between a corresponding periphery extent of the display panel and the boundary.

16. The method of claim 15, further comprising displaying the image data on the display panel.

17. The display method of claim 15, further comprising:
receiving the controlling signals; and
projecting the light selectively controlling the respective light projection to gradually vary the projection of the light based upon the controlling signals.

18. A method for enlarging an apparent size of a display panel, the method comprising:
analyzing brightness and color information of image data;
calculating optimum levels of at least one varying of corresponding brightness and color for one or more periphery elements attached to the display panel based on the analyzed brightness and color information, with the optimum levels being set such that a viewer observable sensation of discontinuity between the display panel and the one or more periphery elements is meant to be imperceptible; and
driving an illumination source respectively of the one or more periphery elements according to the calculated optimum levels of the varying of the corresponding brightness and color.

19. The method of claim 18, wherein the driving of the frame illumination source includes selectively turning the frame illumination source on and off.
